(19) United States
(12) Patent Application Publication
(10) Pub. No.: US 2015/0006231 A1
(43) Pub. Date: Jan. 1, 2015

(54) CONVERSION AND/OR CONSOLIDATION OF BUSINESS PROCESS MANAGEMENT SYSTEMS

(71) Applicant: International Business Machines Corporation, Armonk, NY (US)

(72) Inventors: Srinivas Jandhyala, Hyderabad (IN); Vishnu N. Karakkattillathu Vishnu Namboothiri, Cochin (IN); Mahesh Sooryambylu, Uppinangady (IN)

(21) Appl. No.: 13/929,883

(22) Filed: Jun. 28, 2013

(51) Int. Cl. G06Q 10/06

(52) U.S. Cl. CPC G06Q 10/06316
USPC 705/7.26

(57) ABSTRACT

Applying data mining techniques to find properties, documents, and workflow tasks from historical task reports and/or workflow execution reports of existing business process management (BPM) system(s). Finding patterns from the mined data from the BPM reports and deriving ordering of tasks to form at least a part of a new process. Converting a BPM system(s) into a case management system by analyzing the task and/or workflow definition file and BPM reports.

### FIELD OF THE INVENTION

The present invention relates generally to the field of process management, and more particularly to converting disparate business process management systems to an advanced case management system.

### BACKGROUND OF THE INVENTION

Business process management (BPM) is a management paradigm for software control of business processes that views “processes” as the fundamental organizing construct. In order to optimize a process, BPM generally attempts to: (i) provide a concrete representation of every relevant process; (ii) measure how good the process is in abstract from a given case; and (iii) optimize each process. BPM optimizes processes for the purpose of supporting of future cases. BPM works better when its subject processes are predictable. In BPM, the up front investment that the enterprise makes in perfecting its processes will hopefully be paid back in an increase in efficiency over many instances of the process. BPM is widely practiced across industry domains. BPM helps in automating and/or streamlining business processes in organizations to get the work done effectively and efficiently. BPM is built around the concept of automating the business process through a well thought and designed set of work flows which otherwise were performed manually in any organization across the domain. For this reason, organizations started to adapt to BPM to significantly reduce the operational burden as well as to significantly increase the consistency in processing similar instantiations of the business processes.

Case management (CM) is a software control paradigm which is an alternative to the BPM paradigm. CM is generally used when processes are not repeatable. In CM, each case represents a situation, but these situations do not necessarily require, or entail, processes. CM focuses on communication of goals and intent. CM focuses on information tools and capabilities that can be used by a “case manager” on demand. These tools may include information collecting tools and communications resources. Case management is conventionally used when the relevant processes are unpredictable, stochastic, or at least not repeatable enough to warrant BPM-type focus on the nature of the processes as such. CM is built around the concept of processing a case, a collection of information and coordinated tasks, by knowledge workers (or case workers) to achieve a desired outcome. In CM, these tasks can be: (i) defined up front at the solution design time; or (ii) ad hoc tasks created by a case worker at run-time. In CM, case workers are also empowered to make a judgment on which of the defined tasks needs to be run for specific case instance based on the information that the case worker has.

BPM puts its emphasis on automating an organization's business processes (through a once carefully designed and defined workflow), or in other words it is process centric. In contrast, CM recognizes that not all business problems can be described completely and/or completely reduced to complete software control. For these irreducible business problems, CM further recognizes the need to handle partially repeatable processes with appropriate case worker intervention. In traditional BPM systems, there is no provision for these case workers to intervene and use their human judgment to (at least partially) control business process execution. To summarize, some business processes are amenable to BPM style software control, while other business processes are better handled with CM style process control software.

Data mining is the computational process of discovering patterns in large data sets involving methods that draw upon areas of interest including: (i) artificial intelligence; (ii) machine learning; (iii) business intelligence (BI); (iv) statistics and (v) database systems. The overall goal of the data mining process is to extract information from a data set and transform it into an understandable structure for further use. Data mining includes: (i) raw analysis of data; (ii) database and data management; (iii) data pre-processing; (iv) model and inference considerations; (v) interestingness metrics; (vi) complexity considerations; (vii) post-processing of discovered structures; (viii) visualization; and (ix) online updating. The actual data mining task is the automatic or semi-automatic analysis of large quantities of data to extract previously unknown interesting patterns such as: (i) groups of data records (cluster analysis); (ii) unusual records (anomaly detection); and (iii) dependencies (association rule mining). Data mining uses information from past data to analyze the outcome of a particular problem or situation that may arise. Oftentimes, data mining is generalized to any kind of computer decision support system, such as BI.

BI is a set of theories, methodologies, processes, architectures, and technologies that transform raw data into meaningful and useful information for business purposes. BI can handle large amounts of information to help identify and develop new opportunities. Making use of new opportunities and implementing an effective strategy can provide a competitive market advantage and long-term stability. BI technologies provide historical, current and predictive views of business operations. Common functions of business intelligence technologies include: (i) reporting; (ii) online analytical processing; (iii) analytics; (iv) data mining; (v) process mining; (vi) complex event processing; (vii) business performance management; (viii) benchmarking; (ix) text mining; (x) predictive analytics; and (xi) prescriptive analytics.

### SUMMARY

Embodiments of the present invention disclose a method, computer program, and system having a process that includes: (i) applying data mining to workflow definitions of a set of business process management (BPM) system(s) and to historical data associated with the set of BPM system(s) to find a plurality of properties of the set of BPM system(s); and (ii) defining at least a portion of a new process based, at least in part, on the plurality of properties.

### BRIEF DESCRIPTION OF THE SEVERAL VIEWS OF THE DRAWINGS

FIG. 1 is a schematic view of a first embodiment of a computer system (that is, a system including one or more processing devices) according to the present invention;

FIG. 2 is a schematic view of a computer sub-system (that is, a part of the computer system that itself includes a processing device) portion of the first embodiment computer system;

FIG. 3 is a first flowchart showing a process performed, at least in part, by the first embodiment computer system;

FIG. 4 is a schematic view of a portion of the first embodiment computer system;

FIG. 5 is a second flowchart showing a process performed, at least in part, by the first embodiment computer system.

### DETAILED DESCRIPTION

This Detailed Description section is divided into the following sub-sections: (i) The Hardware and Software Environment; (ii) Operation of Embodiment(s) of the Present Invention; (iii) Further Comments and/or Embodiments; and (iv) Definitions.

### I. THE HARDWARE AND SOFTWARE ENVIRONMENT

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

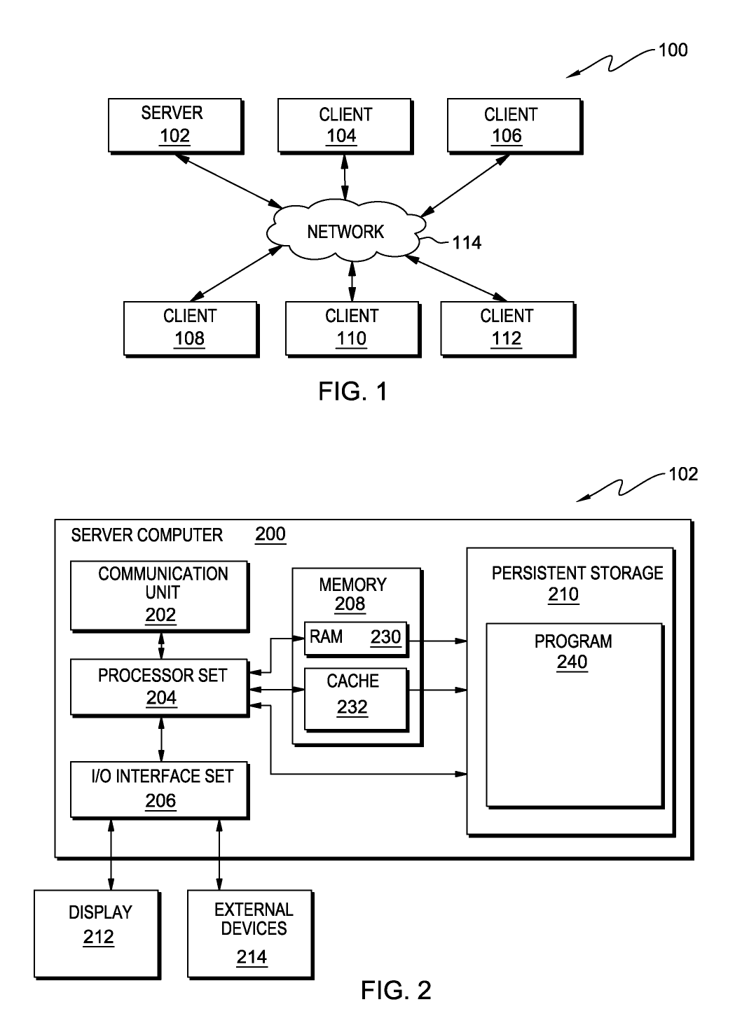

An embodiment of a possible hardware and software environment for software and/or methods according to the present invention will now be described in detail with reference to the Figures. FIGS. 1 and 2 collectively make up a functional block diagram illustrating various portions of distributed data processing system 100, including: server computer sub-system (that is, a portion of the larger computer system that itself includes a computer) 102; client computer sub-systems 104, 106, 108, 110, 112; communication network 114; server computer 200; communication unit 202; processor set 204; input/output (i/o) unit 206; memory device 208; persistent storage device 210; display device 212; external device set 214; random access memory (RAM) devices 230; cache memory device 232; and program 240.

As shown in FIG. 2, server computer sub-system 102 is, in many respects, representative of the various computer sub-system(s) in the present invention. Accordingly, several portions of computer sub-system 102 will now be discussed in the following paragraphs.

Server computer sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 240 is a collection of machine readable instructions and/or data that is used to create, manage and control certain software functions that will be discussed in detail, below, in the Operation Of the Embodiment(s) sub-section of this Detailed Description section.

Server computer sub-system 102 is capable of communicating with other computer sub-systems via network 114 (see FIG. 1). Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

It should be appreciated that FIGS. 1 and 2, taken together, provide only an illustration of one implementation (that is, system 100) and does not imply any limitations with regard to the environments in which different embodiments may be implemented. Many modifications to the depicted environment may be made, especially with respect to current and anticipated future advances in cloud computing, distributed computing, smaller computing devices, network communications and the like.

As shown in FIG. 2, server computer sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 240 is stored in persistent storage 210 for access and/or execution by one or more of the respective computer processors 204, usually through one or more memories of memory 208. Persistent storage 210: (i) is at least more persistent than a signal in transit; (ii) stores the device on a tangible medium (such as magnetic or optical domains); and (iii) is substantially less persistent than permanent storage. Alternatively, data storage may be more persistent and/or permanent than the type of storage provided by persistent storage 210.

Program 240 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102, such as client sub-systems 104, 106, 108, 110, 112. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 240, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. OPERATION OF EMBODIMENT(S) OF THE PRESENT INVENTION

Preliminary note: The flowchart and block diagrams in the following Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

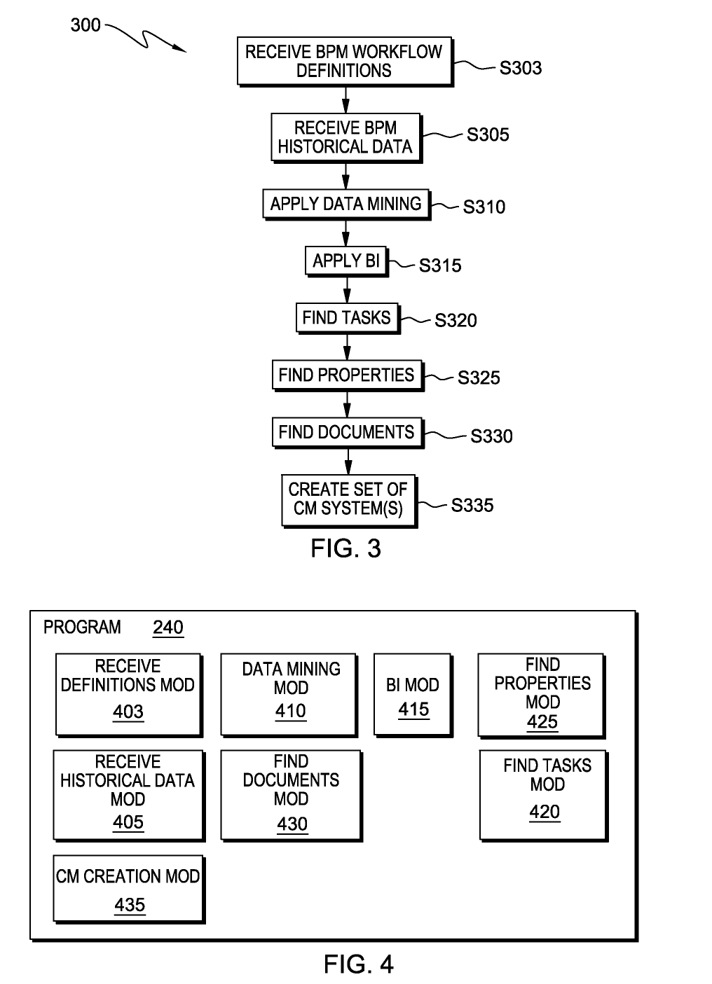

FIG. 3 shows a flow chart 300 depicting a method according to the present invention. FIG. 4 shows program 240 for performing at least some of the method steps of flow chart 300. This method and associated software will now be discussed, over the course of the following paragraphs, with extensive reference to FIG. 3 (for the method step blocks) and FIG. 4 (for the software blocks).

Processing begins at step 5303, where receive definitions module 403 receives BPM workflow definitions from a set of pre-existing BPM system(s). In this embodiment, workflow definitions for two BPM processes are received. Alternatively, workflow definitions for one, or more than two, BPM processes could be received. The BPM processes are conventional BPM processes that, at least in this embodiment, were created long before step 5303 is performed. In this embodiment, it is desired to consolidate the two received BPM processes into an ACM process, but other embodiments of the present disclosure may have other objectives, such as consolidating two BPM processes into a new BPM process.

Processing proceeds to step S305, where receive historical data module 405 receives historical data from a set of pre-existing BPM system(s). Because the BPM processes, whose definitions were received at step S303, existed and have been practiced for a long time, there is much data, referred to herein as historical data, about how these processes worked on real work in the real world. Historical data includes, but is not limited to: (i) the run time instances having the execution details in the form of historical workflow execution reports. When historical data is maintained, it can be of great help in creating new processes (whether BPM or ACM) that will work even better than the pre-existing BPM processes.

Processing proceeds to step S310, where data mining module 410 applies data mining technology to the workflow definitions and historical data received in steps S303 and S305. In some embodiments of the present invention, data mining technology is applied to historical workflow execution reports. The historical workflow execution reports are mined from the legacy BPM system(s). The historical workflow execution reports may be found, for example, in the following locations: (i) database; (ii) file system; and/or (iii) content management repository.

Processing proceeds to step S315, where BI module 415 applies business intelligence technology to the workflow definitions and historical data received in steps S303 and S305. The BI module extracts from the mined data artifacts in the execution reports including: (i) properties; (ii) documents; and (iii) tasks.

Processing proceeds to step S320, where find tasks module 420 finds tasks associated with the workflow definitions and historical data received in steps S303 and S305. Consider a credit card dispute management system where one task, or workflow, is called, “review dispute item.” Review dispute item may include several steps, one of which may be the identify dispute step performed by an employee of the credit card dispute management division (a knowledge case worker) who belongs to the role of customer service representative (CSR).

Processing proceeds to step S325, where find properties module 425 finds properties associated with the workflow definitions and historical data received in steps S303 and S305. Returning to the credit card dispute management system example discussed above, the identify dispute step may constitute several properties including, but not limited to: (i) customer name; (ii) transaction identification; (iii) transaction description; and (iv) account identification.

Processing proceeds to step 5330, where find documents module 430 finds documents associated with the workflow definitions and historical data received in steps S303 and S305. Returning again to the credit card dispute management system example discussed above, the identify step may require the CSR to attach the file named “dispute data,” whether sent by the customer or created by the CSR based on customer input. The dispute data file, or document, which is attached during the execution of the identify dispute step is an artifact from execution of the task, “review dispute item.”

Processing proceeds to step 5335, where CM creation module 435 creates a set of CM system(s) based on the results of processing the workflow definitions and historical data received from a set of pre-existing BPM system(s). The set of CM system(s) includes tasks that involve knowledgeable case workers' judgment, which would not have been present in the previous BPM processes (because they were BPM processes). The historical data of the BPM processes can help mod 435 create a new ACM process where the knowledge worker intervention step(s) are designed, and/or located within the larger ACM process, optimally and intelligently. Once the constituent parts of the specific business solution are identified (including properties, documents, tasks and such case types), CM creation module 435 derives the case management system.

### III. FURTHER COMMENTS AND/OR EMBODIMENTS

With the introduction of traditional BPM systems, to automate all/most of their business processes, many organizations (in their information technology (IT) systems) started to adapt to well designed, engineered workflows which are built to automate their business processes. These BPM systems continue to be the engine of business processing in those many organizations/across their IT systems. That means they continue to follow the old model of BPM which doesn't provide the scope for knowledgeable case workers to get involved when the process is being run. In other words, the older style of BPM process automation will be lacking the involvement of knowledgeable case workers to use their judgment in certain steps based on the run time behavior of that particular case in action). Some embodiments of the present disclosure provide a system which will help organizations to shift from BPM control software to CM control software by reusing existing business process workflows. For example, assume that there are several instances of mergers and acquisitions where a first organization merges with and/or acquires a second organization. In these cases, it is not uncommon to find that corresponding business units of the parent business entities have different sets of business workflows that must be combined and/or consolidated in the corresponding business unit of the merged business entity. Some embodiments of the present disclosure cater to the unification and/or consolidation of several similar workflows (in the same line of business, solving the same business problem) which are designed and/or being run across heterogeneous BPM systems.

Various embodiments of the present disclosure may do one or more of the following: (i) unifying and/or integrate related tasks running in various types of BPM systems; (ii) unify and/or integrate tasks running in a single BPM system; and/or (iii) convert process control from a BPM style to CM style software control system, especially when a particular business process is more optimally handled under the CM paradigm. Some embodiments of the present invention provide one or more of the following: (i) a method to unify business processes running across heterogeneous BPM systems; and/or (ii) a methodology with which these (tasks running in BPM systems) can be moved to the CM paradigm.

According to some embodiments of the present disclosure, the BPM system is defined in BPMN notation (Business Process Modeling Notation). Run time instances of these BPMN notations will have the execution details mentioned in the form of a task execution report. This task execution report may be of various kinds, generally varying dependent upon the practices of the BPM vendor. These task execution reports will usually include at least the following details: (i) the identity of tasks that have run; (ii) the order they have run; (iii) actions that triggered the tasks; and (iv) the kind of documents that got attached to the task instance during the run time. From the task definition file (which adhere to standard BPMN), the specific task information/definition can be determined. Furthermore, analyzing the run time reports will give insight into various other artifacts, such as: (i) order/relevance of various tasks; (ii) the property definitions; and/or (iii) the variety of attachments and other particulars, like whether the task is an optional task. Moreover, the circumstances in which particular tasks are run, or not run, can be determined. This helps with grouping various tasks. According to some embodiments of the present disclosure, the information analyzed from these reports form building blocks of a solution or a CM system which will encompass these tasks.

In some embodiments of the present disclosure, a task execution report, written in BPMN, is serialized in the form of XML (Extensible Markup Language) Process Definition Language, called XPDL. XPDL is an industry standard way defining and/or exchanging BPMN in XML form. From the XPDL definitions corresponding to specific tasks, properties and task definition can be determined. Using a content analytics tool, which is being run on the business process run time instance reports, certain information is determined, such as: (i) order of the tasks being run; (ii) at the run time, what kind of documents get attached; (iii) subtle aspects like grouping of tasks; (iv) whether the task is optional; (v) the spectrum of values the properties can take; (vi) the values that trigger the task; and (vii) etc.

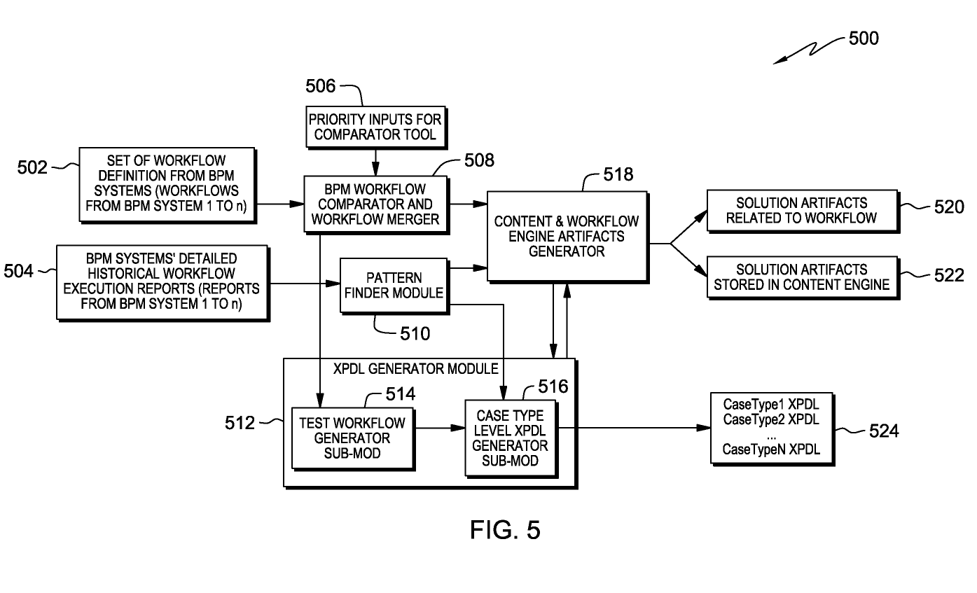

As shown in FIG. 5, system diagram 500 includes: first input block 502; second input block 504; priority tool 506; comparator block 508; pattern finder module 510; XPDL generator module 512; task workflow generator sub-module 514; case level XPDL generator sub-module 516; artifacts generator module 518; workflow-related solution artifacts module 520; content engine solution artifacts module 522; and case type output block 524. The flow of information between, and among, the various blocks is indicated by arrows in diagram 500, which will now be discussed in detail.

Input to the system, according to the embodiment of diagram 500 will now be discussed. First input block 502 represents workflow definition. The workflow definition input is represented in BPMN. From two or more heterogeneous BPM systems (collectively called the “source BPM systems”), these workflow definition files are obtained. Each workflow definition file adheres to BPMN. Collectively, these workflow definition files are the first input for the present embodiment of the present disclosure.

Second input block 504 represents historical workflow execution reports (also called run time reports) from the source BPM systems. The run time reports will be in a certain text format, with the exact format depending upon the BPM system designer. The run time reports are generated when the workflow is being executed by the BPM source system to which the run time report applies, meaning that the process will have been automated through BPM. Accordingly, run time reports generated from these run time instances, over some historical period of time, serve as the basis for further analysis.

As shown in FIG. 5, comparator block 508 represents BPM workflow comparator and workflow merger software that reads the individual XPDL files. These XPDL files belong to BPM system 1 to n, and each may belong to the same or different business process management systems. This is built on mathematical modeling which compares the workflow definitions. Comparator block 508 deduces similarities in the respective workflows from the workflow definitions. Based on the deduced similarities, the workflows are merged by comparator block 508. In some embodiments, the comparator block uses currently conventional algorithms and/or methodologies to compare the BPM workflows. After comparing various workflows definitions, comparator block 508 comes up with a list of non-identical workflows. These workflows may include consolidated BPM workflows, in cases where similar workflows have been merged.

As shown in FIG. 5, priority tool 506 represents software that defines a priority order of workflows so it is determined which workflows from which system will have higher priority when compared to another. For example, priority tool 506 is useful in a “use case” where Business Conglomerate A acquires Organization B (which is in similar line of business) so that the merged business entity AB wants to streamline their workflows (business processes) and where business entity AB has a pre-defined priority order in mind with regard to the various business processes of the parent entities.

As shown in FIG. 5, pattern finder module 510 works on the run time history reports from various BPM systems. Module 510 is designed based on the content analytics technology. The BPM reports are usually text files (may be in any format; pdf, doc, txt etc). Module 510 analyzes the reports to find the pattern between different tasks and does (or at least attempts to do) the following: (i) correlate each of the respective reports based on the business process that a similar set of reports was respectively automating; (ii) determines each report's respective ordering of the relevant tasks; (iii) deduces the roles which execute the steps in these tasks; (iv) understands the in-basket definitions which are defined for these roles; (v) understands what are the trigger conditions; (vi) within such ordered group of tasks it will group some to a set; (vii) decides which ordered group of tasks form an inclusive set; (viii) decides which ordered group of tasks form an exclusive set; (ix) deduces which tasks of an ordered group of tasks are optional; and/or (x) determines other insights that can be determined by a pattern finding algorithm on the run time reports of the workflow using a text analytics engine. In this way, pattern finder module 510 not only provides a logical grouping of tasks, but also considers a way to define a business case from the order of related tasks being executed.

As shown in FIG. 5, artifacts generator block 518 represents software that generates content and workflow engine artifacts. More specifically, artifacts generator block 518: (i) reads the individual XPDL files, which have been ordered and grouped through comparator block 508; (ii) extracts information such as attributes (including attribute types, minimum/maximum attribute values (if any)) and document types; and (iii) takes input from pattern finder module 510 such as information deduced from the run time report analysis. The system of diagram 500 uses these extracted artifacts to start constructing a CM system definition object (also referred to as a “solution object”). The solution object refers to all the related tasks which were earlier executed as independent BPM tasks, and which may have originally come from different and disparate BPM systems. The solution object encompasses attributes, document types, and reference to the related group of tasks. Any business solution to be defined in any enterprise content management system has two types of artifacts: (i) content engine artifacts which is constituted by definitions of various solution objects (see content engine solution artifacts block 522); and (ii) workflow engine artifacts (see workflow-related solution artifacts block 520). The workflow engine is software that carries out and/or automates the business process execution on behalf of the enterprise content management system in which solution is to be deployed.

Some embodiments of the present disclosure construct a grouping of tasks on a per-business-case basis and are able to define that using XPDL generator module 512 by understanding the patterns in the run time history of individual BPM tasks' respective execution(s). As shown in FIG. 5, XPDL generator module 512 includes: task workflow generator sub-module 514; and case type level XPDL generator sub-module 516. XPDL generator module 512 converts the workflow definition in BPMN into XPDL format (it should be kept in mind that one BPMN file represents one task). In this embodiment, the conversion of BPMN to XPDL by task workflow generator sub-module 514 is accomplished using currently conventional techniques and/or software. Sub-module 514 takes its input from comparator block 508 where very similar workflows have been grouped together. This grouping can be helpful because XPDL as expressed in BPMN may be less than ideally comprehensive, or robust, and would therefore only define a smaller world which is only specific to that workflow. However, when task level XPDL is defined, then this definition will comprise other inputs deduced from pattern finder module 510. This is true even though the task level XPDL is only specific to a particular task, and/or part of a business case. The other inputs from pattern finder module 510 may include the following: (i) whether this task part of set, an inclusive task or a normal task; (ii) the specific document types triggering this task; and/or (iii) the properties specific to this task. In order to accomplish this, case type level XPDL generator sub-module 516 takes the input from pattern finder module 510 and from task workflow generator sub-module 514 in order to define the logical grouping of tasks belonging to a business case.

As explained above, the workflow definitions (see first input block 502) from disparate BPM systems are analyzed and deduced to arrive at a list of case type definitions belonging to a business solution, as shown in case type output block 524 of FIG. 5. As further shown in FIG. 5, artifacts generator block 518 and XPDL generator module 512 provide the outputs 520, 522, 524 corresponding to a business solution. This business solution includes: (i) case types; (ii) properties; (iii) document types; (iv) in-basket definitions; (v) roles; (vi) etc. In the business solution, the definition of tasks specific to each case type will be referred in the artifacts generator block 518. This completes the 360 degree definition of the business solution. The final output is the definitions of a complete business solution which will be deployed in the content engine and to make use of a workflow engine for the execution of business cases specific to already defined case types. It should be noted that content engine and workflow engines are not shown in FIG. 5. The output is the generation of a business solution that can be executed in a CM paradigm. Content engine, in this context (workflow-related solution artifacts module 520 and content engine solution artifacts module 522) is specific to the CM paradigm.

Some embodiments of the present disclosure may have one or more of the following features, characteristics and/or advantages: (i) applying data mining techniques to find properties, documents, workflow tasks from the historical workflow and other reports of existing BPM systems (for example, pattern finder module 510, shown in FIG. 5, accomplishes that); (ii) finding patterns from the historical workflow execution reports of the traditional BPM systems to derive ordering of tasks to form part of case solution; (iii) finding patterns from the historical workflow execution reports of the traditional BPM systems to derive a business case; (iv) using mathematical modeling techniques for comparing workflows in workflow comparator module 508 (BPM work flow comparator) for merging the workflows; (v) deriving of the workflow and content artifacts, expressed in XPDL, using a content and workflow artifacts generator (such as, artifacts generator block 518 of FIG. 5); (vi) provision for the user to set and/or define priority when dealing with various workflows during merging of the workflows; (vii) consolidation and conversion of disparate BPM systems into a CM paradigm solution using a pattern finder (for example pattern finder module 510 shown in FIG. 5), a BPM workflow comparator (for example, comparator block 508 shown in FIG. 5), and a content and workflow artifacts generator (for example, artifacts generator block 518 of FIG. 5); (viii) providing a methodology to define a business solution from already-running BPM tasks; and/or (ix) flexibility in executing some of the intricate steps which involve knowledgeable case workers' judgment.

While some embodiments of the present disclosure can help an organization move from BPM to ACM (Advanced Case Management paradigm), other embodiments may be used to streamline the automation of business processes, which may be in disparate BPM systems.

Some embodiments of the present invention may include one or more of the following features, characteristics and/or advantages: (i) applying data mining techniques on execution reports of heterogeneous BPM systems to derive at case type artifacts; (ii) applying BI techniques on execution reports of heterogeneous BPM systems to derive at case type artifacts; (iii) deriving workflow artifacts required for a case type in a CM system by analyzing execution history of workflows to identify relevant patterns and/or content; and (iv) identifying case objects, properties, and ordering of tasks to derive a business solution comprising case type definitions.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: non-exclusive or; for example, A and/or B means that: (i) A is true and B is false; or (ii) A is false and B is true; or (iii) A and B are both true.

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (ii) in a single proximity within a larger piece of software code; (iii) located within a single piece of software code; (iv) located in a single storage device, memory or medium; (v) mechanically connected; (vi) electrically connected; and/or (vii) connected in data communication.

Software storage device: any device (or set of devices) capable of storing computer code in a non-transient manner in one or more tangible storage medium(s); “software storage device” does not include any device that stores computer code only as a signal.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

What is claimed is:

1-7. (canceled)

8. A computer program product comprising software stored on a software storage device, the software comprising:
first program instructions programmed to apply data mining to workflow definitions of a set of business process management (BPM) system(s) and to historical data associated with the set of BPM system(s) to find a plurality of properties of the set of BPM system(s); and
second program instructions programmed to define at least a portion of a new process based, at least in part, on the plurality of properties.

9. The computer program product of claim 8 further comprising:
third program instructions programmed to apply data mining to workflow definitions of a set of BPM system(s) and to historical data associated with the set of BPM system(s) to find a plurality of tasks of the set of BPM system(s); and
the second program instructions programmed to define at least a portion of a new process based, at least in part, on the plurality of properties and the plurality of tasks.

10. The computer program product of claim 9 further comprising:
fourth program instructions programmed to apply data mining to workflow definitions of a set of BPM system(s) and to historical data associated with the set of BPM system(s) to find a plurality of documents of the set of BPM system(s); and
the second program instructions programmed to define at least a portion of a new process based, at least in part, on the plurality of properties, the plurality of tasks and the plurality of documents.

11. The computer program product of claim 8 further comprising:
third program instructions programmed to apply business intelligence to workflow definitions of a set of business management process(es) and to historical data associated with the set of BPM system(s) to help find the plurality of properties of the set of BPM system(s).

12. The computer program product of claim 11 further comprising:
fourth program instructions programmed to apply business intelligence to workflow definitions of a set of BPM system(s) and to historical data associated with the set of BPM system(s) to find a plurality of tasks of the set of BPM system(s);
fifth program instructions programmed to apply business intelligence to workflow definitions of a set of business management process(es) and to historical data associated with the set of BPM system(s) to find a plurality of documents of the set of BPM system(s); and
the second program instructions programmed to define at least a portion of a new process based, at least in part, on the plurality of properties, the plurality of tasks and the plurality of documents.

13. The computer program product of claim 8 wherein the new process is a case management (CM) process that includes involvement of a knowledge worker.

14. A computer system comprising:
a processor(s) set; and
a software storage device;
wherein:
the processor set is structured, located, connected and/or programmed to run software stored on the software storage device; and
the software comprises:
first program instructions programmed to apply data mining to workflow definitions of a set of business process management (BPM) system(s) and to historical data associated with the set of BPM system(s) to find a plurality of properties of the set of BPM system(s); and
second program instructions programmed to define at least a portion of a new process based, at least in part, on the plurality of properties.

15. The computer system of claim 14 wherein the software further comprises:
third program instructions programmed to apply data mining to workflow definitions of a set of BPM system(s) and to historical data associated with the set of BPM system(s) to find a plurality of tasks of the set of BPM system(s); and
the second program instructions programmed to define at least a portion of a new process based, at least in part, on the plurality of properties and the plurality of tasks.

16. The computer system of claim 15 wherein the software further comprises:
fourth program instructions programmed to apply data mining to workflow definitions of a set of BPM system(s) and to historical data associated with the set of BPM system(s) to find a plurality of documents of the set of BPM system(s); and
the second program instructions programmed to define at least a portion of a new process based, at least in part, on the plurality of properties, the plurality of tasks and the plurality of documents.

17. The computer system of claim 14 wherein the software further comprises:
third program instructions programmed to apply business intelligence to workflow definitions of a set of business management process(es) and to historical data associated with the set of BPM system(s) to help find the plurality of properties of the set of BPM system(s).

18. The computer system of claim 17 wherein the software further comprises:
fourth program instructions programmed to apply business intelligence to workflow definitions of a set of BPM system(s) and to historical data associated with the set of BPM system(s) to find a plurality of tasks of the set of BPM system(s);
fifth program instructions programmed to apply business intelligence to workflow definitions of a set of business management process(es) and to historical data associated with the set of BPM system(s) to find a plurality of documents of the set of BPM system(s); and
the second program instructions programmed to define at least a portion of a new process based, at least in part, on the plurality of properties, the plurality of tasks and the plurality of documents.

19. The computer system of claim 14 wherein the new process is a case management (CM) process that includes involvement of a knowledge worker.
